(19) United States
(12) Patent Application Publication
(10) Pub. No.: US 2007/0288612 A1
(43) Pub. Date: Dec. 13, 2007

(54) ASSEMBLY, AND ASSOCIATED METHOD, FOR PROVISIONING COMPUTER DEVICE WITH COMPUTER DATA

(75) Inventor: Eric Hall, Allen, TX (US)

Correspondence Address: SCHEEF & STONE, L.L.P., 5956 SHERRY LANE, SUITE 1400, DALLAS, TX, 75225, US

(73) Assignee: ELECTRONIC DATA SYSTEMS CORPORATION, Plano, TX (US)

(21) Appl. No.: 11/423,558

(22) Filed: Jun. 12, 2006

(51) Int. Cl. G06F 15/173

(52) U.S. Cl. 709/223

(57) ABSTRACT

An assembly, and an associated method, for provisioning a computer server, or other computer device, with operating system software and other computer data. A mobile start cart is positioned at a build area at which provisioning data is broadcast. The broadcast data is detected by a communication element of the mobile start cart. A communication element of the start cart is also placed into wireless, communication connectivity with the computer server. Provisioning data detected at the mobile start cart is forwarded on to the computer server to provision the computer server.

The present invention relates generally to a manner by which to provision a computer device, such as a computer server, with computer data, such as data forming the operating system of the computer device. More particularly, the present invention relates to an assembly, and an associated method, by which to provision the computer device with computer data at a secure location, free of wired connection with the computer device. A wireless infrastructure is installed, or made available, at a build area. Wireless communication connectivity is provided by way of mobile-positioned communication elements at the build area. Provisioning data, broadcast by the wireless infrastructure, is forwarded to the computer device and used, once delivered to the computer device, to provision the computer device.

Provisioning of the computer device is carried out without need to install a relatively expensive Ethernet infrastructure forming a wired connection with the computer device. Rather, a relatively low-cost wireless infrastructure, more easily and economically installed, or otherwise made available, is used for the computer device provisioning.

### BACKGROUND OF THE INVENTION

New types of communication systems and services have been developed and deployed in recent years, permitted as a result of advancements in communication technologies. Digital data networks, e.g., both those permitting public access and those limited to private access, are regularly utilized by many through which to communicate data pursuant to performance of a communication service.

In a conventional data network, data that is communicated is generally formatted into data packets, and discrete data packets are communicated between a set of communication stations coupled to the data network, thereby to communicate the data therebetween.

A data retrieval service is an exemplary type of communication service performed by way of a data network. In a typical data retrieval service, a first communication device requests retrieval of data from a second communication device. Upon detection of the request, the second communication device retrieves the data and sends the retrieved data to the requesting device or its proxy.

In many data retrieval services, a computer server forms the requested communication station, that is, the communication station at which data is stored and from which data is retrieved.

Computer servers are connected, for instance, to public data networks, such as the Internet. And, requests for data retrieval from a computer server connected to the Internet are routed, by way of the Internet, to the computer server. And, once retrieved, the retrieved data is returned, also by way of the Internet. A computer server connected to a private network operates analogously. That is to say, a request for data is routed by way of the private network to the computer server. And, once retrieved, the data is returned to the requesting device, also by way of the private data network. Private networks are created, for instance, for a business, governmental, or other entity in which access to the network is limited and not generally accessible by the general public.

A computer server typically is not in a production-ready state upon its manufacture. That is to say, the hardware of the computer server, once manufactured and assembled, must be provisioned with an operating system as well as other software. The operating system is installed, typically, with software packages and specified patches.

While various mechanisms are available by which to facilitate the provisioning of a computer server, such mechanisms generally rely upon the availability of an Ethernet connection by which to connect the computer server to a source of the software that is to be provided to the server. The server is provisioned with operating system and other software by way of the Ethernet connection. An exemplary such mechanism, an OPSWARE™ server automation system (SAS) facilitates automatic management of WINDOWS™, LINUX™, and UNIX™ server and application software. OPSWARE™ includes the capability of operating system provisioning (OSP). Operation of OPSWARE™ permits an assembled computer server in a “bare metal” state to be provisioned into a “production-ready” state through the installation of an appropriate operating system with specified patches and software packages. SOLARIS™-based, LINUX™-based, and WINDOWS™-based computer servers are all exemplary of computer-server types that are able to be provisioned through operation of the OPSWARE™ operating system provisioning.

The conventional reliance upon the Ethernet connection, however, limits the locations available at which to provision the computer server. Security constraints also sometimes limit the location at which a computer server is permitted to be provisioned. That is to say, security requirements sometimes prohibit a computer server from being connected to a production network, private or public, until the computer server has been built out to an acceptable security level, typically requiring the computer server to have a completed, base operating system installed, as well as installation of associated service packs and security patches and, e.g., third-party, security products, such as anti-virus software.

In one conventional manner by which to provision a computer server, the computer server is delivered to a physically-isolated build area that contains a wired, Ethernet infrastructure. The computer server is provisioned and then transported to a production location. The computer server, however, requires multiple transport actions, that is to say, transport to the isolated build area and subsequent transport to the production location.

Alternately, if the production location at which the computer server is permanently to be positioned contains structure of a wired build network, i.e., forms an isolated build area having a wired-Ethernet infrastructure, the multiple transport of the computer server to provision the server with the operating software is obviated. However, costs associated with the installation of a separate, wired Ethernet build network are sometimes prohibitively expensive and, oftentimes, such installation is not a practical solution.

What is needed is an improved manner by which to provide for the provisioning of a computer server, or other computer device.

It is in light of this background information that the significant improvements of the present invention have evolved.

### SUMMARY OF THE INVENTION

The present invention, accordingly, advantageously provides an assembly, and an associated method, by which to provision a computer device, such as a computer server, with computer data, such as data defining operating system software, or other operating software.

Through operation of an embodiment of the present invention, a manner is provided by which to provision the computer device with the computer data free of a wired connection, such as an Ethernet link, with the computer device.

As the computer device is provisioned with provisioning data at a build area that does not require installation of an Ethernet infrastructure, greater freedom in the selection of the build area is permitted. Wireless connectivity, provided by way of either a wireless local area network (WLAN) or a wide area network (WAN), is used by which to provision the computer device. Wireless infrastructure is more easily, and cost-effectively, made available to a build area, facilitating provisioning of a computer device at a more convenient location, such as a production area at which the computer device shall be permanently operated.

In one aspect of the present invention, the wireless infrastructure installed at a build area forms a wireless local area network having an access point that broadcasts the computer data that is used to provision the computer device. The broadcast data is formatted, for instance, pursuant to the operating protocols of an IEEE 802.11(a) standard specification. Or, for instance, the provisioning data is formatted pursuant to the operating protocols of an IEEE 802.11(b) standard specification. And, alternately, for instance, the provisioning data is formatted pursuant to the operating protocols of an IEEE 802.11(g) standard specification.

Alternately, the wireless connectivity is provided by way of a wide area network, such as a cellular communication network that provides for data communication services, such as GSM/GPRS/EDGE communication services or EV-DO services. Encryption, e.g., using encryption keys by which to encrypt the data that is communicated, is used to ensure the security of the communicated data.

In another aspect of the present invention, a mobile support assembly is positionable at the build area at which the computer server, or other, device is to be provisioned. The support assembly includes mechanisms that provide communication connectivity between the wireless infrastructure and the device that is to be provisioned with the computer data. A first communication mechanism is positioned at the support assembly to receive the broadcast of data, broadcast by the wireless infrastructure. And, a second communication mechanism, connected in communication connectivity with the first communication mechanism, forwards on the data received by the first communication mechanism to the communication device, thereby to provision the communication device with the communication data.

A base-metal computer server, or the like, positioned at the build area, is provisioned, thereby, with the provisioning data. No fixed, wireline connection is required to be formed with the computer server, or other computer device. By positioning the support assembly, together with its supported communication mechanisms, the provisioning data, broadcast by the wireless infrastructure is received at the support assembly and forwarded on to the computer server. A build area is, e.g., defined at a production location at which the computer server is to be operated. And, a support assembly containing the communication mechanisms is transported to the build area, used in conjunction with the provisioning of the computer server and then transported to another build area to provide for provisioning of another computer server.

In another aspect of the present invention, a Bluetooth™ connection is established between the computer server and the support-assembly-mounted communication mechanism. When broadcast data is received at the support assembly, indications are provided to the Bluetooth™ transceiver positioned thereat. And, the Bluetooth™ transceiver transmits the data to corresponding Bluetooth™ structure of the computer server. Thereby, the computer server is provided with the provisioning data.

In other aspects of the present invention, the Bluetooth™ transceiver is replaced with another type of transceiver, such as a WI Media transceiver, an ultrawideband (UWB) transceiver, or an IEEE 802.15-compatible transceiver. Corresponding transceiver elements are formed at the computer server to permit the communication of the provisioning data thereto.

And, in another aspect of the present invention, a wireless point-to-point or wireless point-to-multipoint bridge is utilized. Provisioning data detected at the support assembly is forwarded on to the computer server by way of the work bridge. When the work bridge forms a point-to-multipoint work bridge, the provisioning data is able to be communicated to multiple computer servers, thereby to provision multiple computer servers. And, in other implementations, other types of wireless communication devices are utilized, for instance, repeater devices and mobile access points.

Provisioning of the computer server, or other computer device, positioned at the build area is carried out, free of wired connections with the computer server. Ethernet connections, and their associated infrastructure costs, are not required to provision the computer server. Greater freedom in the selection of a build area at which to provision a computer server is thereby provided. Particularly when high levels of security are to be associated with the computer server, the ability to provide a build area at a secure location is better assured.

In these and other aspects, an assembly, and an associated method, is provided for facilitating provisioning of a computer device with provisioning data at a provisioning location. A wireless network connector is configured selectably to receive network-sourced computer data when positioned at the provisioning location. The network-sourced computer data comprises the provisioning data. A wireless computer-device connector is configured to be in communication connectivity with the wireless network connector and with the computer device. The wireless computer-device connector provides the provisioning data received by the wireless network connector to the computer device. A mobile support platform is configured to support the wireless network connector and the wireless computer-device connector. The mobile support platform is positionable at the provisioning location to position the wireless network connector to permit reception of the network-sourced computer data.

### BRIEF DESCRIPTION OF THE DRAWINGS

FIG. 1 illustrates a partial functional block, partial schematic representation of a build area configured pursuant to an embodiment of the present invention.

FIG. 2 illustrates a process diagram representative of exemplary operation of the build area and wireless start cart shown in FIG. 1 to provision a computer server with operating system software, or other computer data.

FIG. 3 illustrates a representation, similar to that shown in FIG. 1, but herein which a mobile start cart of an embodiment of the present invention positioned at the build area.

FIG. 4 illustrates a method flow diagram listing the method of operation of an embodiment of the present invention.

### DETAILED DESCRIPTION

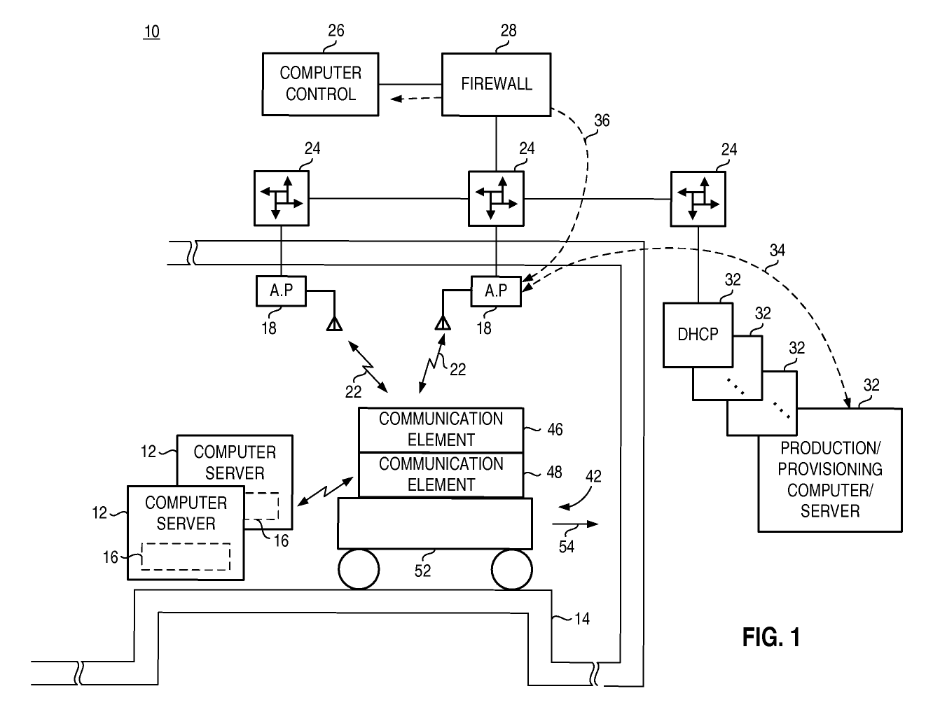

Referring first to FIG. 1, a build area, shown generally at 10, forms a secure area at which to provision a computer server or other computer device. The build area is defined at any area available for provisioning of the computer server, or other device, and, e.g., is formed at a production location at which the computer server shall be operated. Here, a set of computer servers 12 are positioned at the build area, positioned at a raised floor area 14 of the build area.

The computer servers, in the exemplary implementation, while initially in a “bare metal” state, are to be provisioned with operating system software to form a WINDOWS™-based, a LINUX™-based, or a UNIX™-based server.

Boxes 16 at the computer servers 12 are representative of storage locations at which computer data, once provisioned to the computer servers, is stored. While the following description shall describe exemplary operation with respect to provisioning of computer servers with operating system, and other, software, provisioning of any type of computer device with computer data is provided through operation of an embodiment of the present invention. The following description is, therefore, by way of example only and not by way of limitation.

A wireless infrastructure is installed, or available to, the build area. In FIG. 1, a wireless local area network (WLAN) is formed that includes access points 18 at the build area. Two ceiling-mounted, access points are, in the exemplary implementation shown in FIG. 1, positioned at the build area. Provisioning data is broadcast by the access points. The provisioning data that is broadcast is formatted according to a selected protocol, such as the IEEE 802.11(a), the IEEE 802.11(b), or the IEEE 802.11(g) operating protocols. Designations 22 are representative of the data broadcast in the build area, here by way of the access points 18.

The access points are connected to the VLAN by way of ports 24. The VLAN is located, e.g., on switches that are maintained and monitored as part of a maintenance center at which the build area is located. Monitoring and control of the VLAN is exerted by way of a maintenance center computer 26 that is positioned behind a firewall 28.

In the implementation shown in FIG. 1, the provisioning data is sourced at production servers 32. The production servers are also connected to the virtual local area network, also by way of a port 24. The production servers source the operating software that is provided to the access points 18 and broadcast by the access points in the build area. In the exemplary implementation, OPSWARE™ operating system provisioning (OSP) is provided by way of the wireless infrastructure to provision the computer servers 12 with operating system software.

The segments 34 are representative of routing paths extending between a server 32 and an access point 18 by which operating system software, sourced at a server 32, is provided to an access point 18. And, the segment 36 represents a routing path of maintenance and control commands, and input indicia communicated between the maintenance-center computer and an element of the virtual local area network.

A mobile start cart 42 of an embodiment of the present invention is also positioned at the build area. The mobile start cart includes communication mechanism elements 46 and 48 that are supported upon a wheeled platform 52. Here, the mobile start cart is shown, once wheeled into position, at the raised floor of the build area. Wheeled movement of the start cart is represented by the arrow 54 shown in the figure.

The communication element 46 provides for wireless communication connectivity with the wireless infrastructure and, in particular, to receive the broadcasts 22. In one implementation, the communication element forms a mobile wireless local area network repeater. In another implementation, the element 46 forms a mobile wireless local area network access point.

The communication element 48 provides for wireless connectivity with the computer servers 12. In one implementation, the element 48 forms a Bluetooth™ transceiver. In another implementation, the element 48 forms a WI media transceiver. In another implementation, the element 48 forms an ultrawideband (UWB) transceiver. And, in another implementation, the element 48 forms an IEEE 802.15-compliant transceiver.

In another implementation, the elements 46 and 48 together form a mobile WLAN point-to-point bridge. And, in another implementation, the elements 46 and 48 together form a mobile WLAN point-to-multipoint bridge.

In each of the implementations, or combinations thereof, wireless connectivity is provided between the wireless infrastructure and the mobile start cart and also between the mobile start cart and the computer server. Provisioning is carried out free of wired connection with the computer server. Ethernet communication links, conventionally required to be formed with the computer server are obviated. And, free of the need to provide an Ethernet connection, and its associated infrastructure, the build area at which a computer server, or other computer device, is provisioned, is more flexibly defined. That is to say, free of the need to provide for an Ethernet communication link, a build area is formable at a location, such as a production location, at which no Ethernet link connection is available. Merely by providing for the wireless infrastructure and positioning of the wireless start cart at the build area, in communication connectivity with the wireless infrastructure and with the computer server, provisioning of the computer server is carried out. A computer server, to be operated in conjunction with a private network at a secure location, is provisioned at the secure location and subsequently operated thereat. Security concerns associated with provisioning of a computer server remote from its secured, production location are better alleviated.

Increased security is provided by encrypting the data prior to its broadcast. For instance, in one implementation, wireless fidelity (wi-fi) protected access (WPA1) encryption is utilized. In another implementation, WPA2/AES encryption is utilized. Such encryption utilizes 63-bit ASCII keys that generate a 256-bit encryption code. Appropriate keys are provided to the structure supported at the mobile start cart so that the encrypted data received thereat can be de-encrypted.

In one implementation, a production location, i.e., a maintenance center, at which the build area is formed, includes a plurality of separate build areas. Each build area encrypts data using separate WPA-PSK encryption keys. And, in another implementation, TKIP and MIC are utilized to strengthen the encryption and to correct flaws, if any, noticed in the WEP. And, in further implementations, additional security is provided. For instance, the 256-bit encryption key is created using a 64-character, random letter, number, and punctuation symbol sequence. Characters that are produced using a password generator are, e.g., used only one time and are not saved. And, configurations of the equipment are cleared prior to reuse, all to facilitate the security of the encryption.

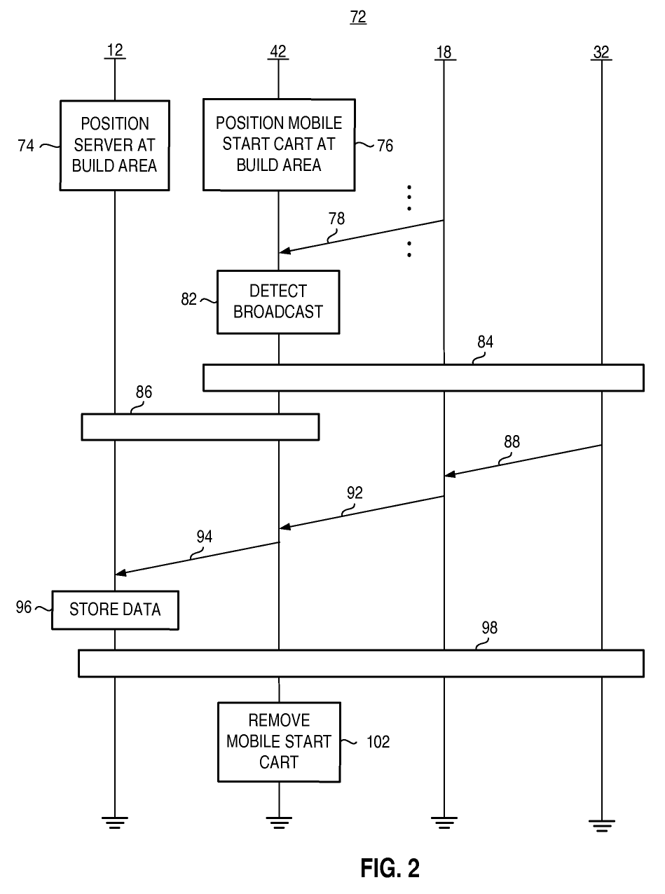

FIG. 2 illustrates a process diagram, shown generally at 72, representative of operation of an embodiment of the present invention implemented by the structure shown in FIG. 1, pursuant to the provisioning of a computer device, such as a computer server 12. The process commences subsequent to installation of the wireless infrastructure at the build area and formation of the virtual local area network of which the wireless network infrastructure forms a portion.

As indicated by the blocks 74 and 76, respectively, a computer server 12 is positioned at the build area, and a mobile start cart 42 is positioned at the build area. Signaling messages, represented by the segment 78, are broadcast by the wireless infrastructure, here by an access point 18. And, as indicated by the block 82, the communication element 46, supported at the mobile start cart, detects the signaling. Responsive to detection of the signaling messages, the communication element enters into a dialog with, indicated by the block 84, with the access point, and, in turn, the provisioning computer 32. Once established, and the mobile start cart is placed into communication connectivity with the computer server, operating system software, and other computer data, sourced at the provisioning computer 32 is provided. Here, the provisioning is represented by the segments 88, 92, and 96. The data provided to the computer server is stored, indicated by the block 96, at the computer server. Upon completion of the provisioning of the computer server, the dialog is terminated, indicated by the block 98. Thereafter, and as indicated by the block 102, the mobile start cart is repositioned elsewhere, operated pursuant to provisioning of other devices.

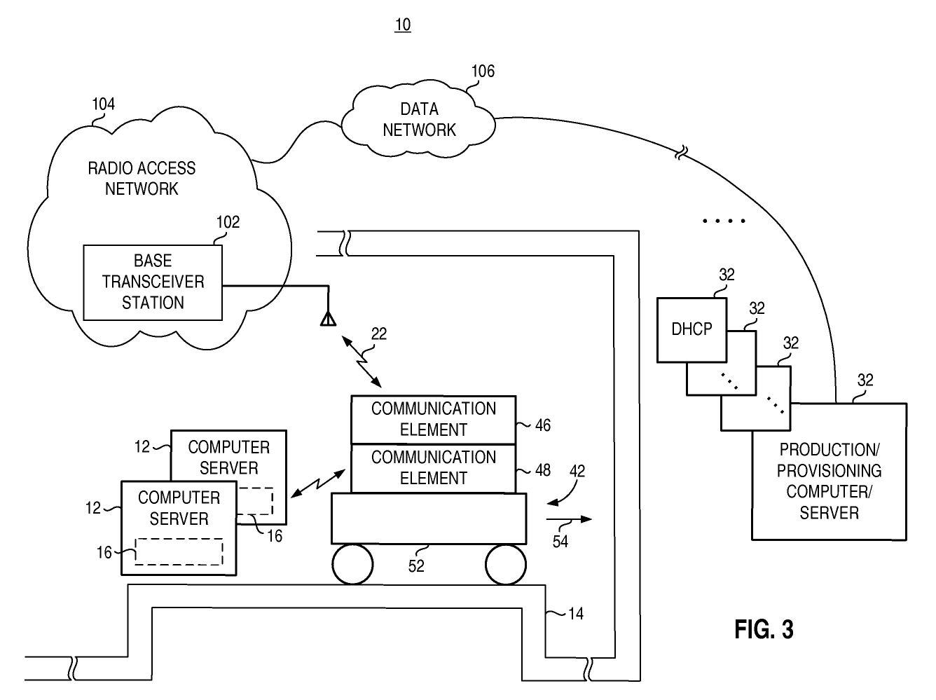

FIG. 3 illustrates the build area 10 pursuant to an alternate implementation of an embodiment of the present invention. Here, provisioning is provided by way of a wide area network, such as a data-capable cellular communication network, such as a GSM/GPRS/EDGE network or an EV-DO network. A base station 102 broadcasts provisioning data, here represented also by the designations 22, in the build area. In one implementation, the base station 102 forms a microcell and is mounted at the build area. In another implementation, the base station 102 is positioned elsewhere but defines a cell that encompasses the build area. Encryption, analogous to that described previously with respect to the implementation shown in FIG. 1, is also provided to facilitate security of communication of the provisioning data.

The base station is connected, by way of a radio network 104, and a data network 106, to the provisioning computers 32 that source the provisioning data. Operation of the mobile start cart is analogous to that described previously. That is to say, a communication element 46 detects the broadcast 22 of the provisioning data, and the communication element 48 is placed into communication connectivity with the computer server. Provisioning of the computer server is carried out by way of wireless connections therewith.

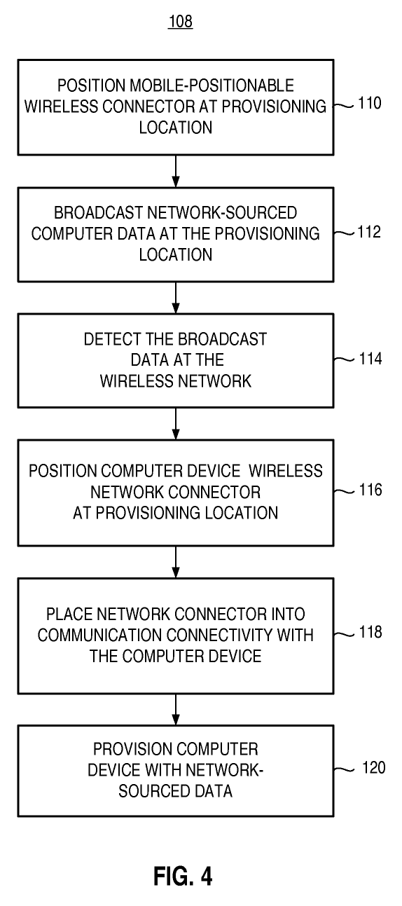

FIG. 4 illustrates a method flow diagram, shown generally at 108, representative of the method of operation of an embodiment of the present invention.

First, and as indicated by the block 110, a mobile-positionable wireless network connector is positioned at a provisioning location. Then, and as indicated by the block 112, network-sourced computer data is broadcast in the provisioning location. As indicated by the block 114, the mobile-positionable wireless network connector detects the network-sourced computer data broadcast in the provisioning location.

A mobile positionable, computer device connector is also positioned, indicated by the block 116, at the provisioning location. The connector is placed into communication connectivity, indicated by the block 118, with the computer device. And, as indicated by the block 120, the computer device is provisioned with the network-sourced data. The network-sourced data forms the provisioning data.

Thereby, free of a wired connection with the computer device, the computer device is provisioned with operating software or other computer data.

The previous descriptions are of preferred examples for implementing the invention, and the scope of the invention should not necessarily be limited by this description. The scope of the present invention is defined by the following claims.

What is claimed is:

1. An assembly for facilitating provisioning of a computer device with provisioning data at a provisioning location, said assembly comprising:
a wireless network connector configured selectably to receive network-sourced computer data, the network-sourced computer data comprising the provisioning data, when positioned at the provisioning location;
a wireless computer device connector connected to said wireless network connector and configured selectably to communicate with the computer device, the network-sourced computer data forming the provisioning data provided to the computer device by way of said wireless computer device connector; and
a mobile support platform configured to support said wireless network connector and the wireless computer device connector, said mobile support platform positionable at the provisioning location to position said wireless network connector to permit reception of the network-sourced computer data and to position said wireless computer device connector to permit communication of the network-sourced computer data to the computer device.

2. The assembly of claim 1 wherein said wireless network connector comprises a wireless local area network, WLAN, point-to-point bridge.

3. The assembly of claim 1 wherein said wireless network connector comprises a wireless local area network, WLAN, point-to-multipoint bridge.

4. The assembly of claim 1 wherein said wireless network connector comprises a mobile wireless local area network repeater.

5. The assembly of claim 1 wherein said wireless network connector comprises a mobile wireless local area network access point.

6. The assembly of claim 1 wherein the network-sourced computer data that said wireless network connector is configured to receive comprises IEEE 802.11(b)-formatted data.

7. The assembly of claim 1 wherein the network-sourced computer data that said wireless network connector is configured to receive comprises IEEE 802.11(a)-formatted data.

8. The assembly of claim 1 wherein the network-sourced computer data that said wireless connector is configured to receive comprises IEEE 802.11(g)-formatted data.

9. The assembly of claim 1 wherein said wireless computer device connector comprises a Bluetooth™ transceiver.

10. The assembly of claim 1 wherein said wireless computer device connector comprises an ultrawideband, UWB, transceiver.

11. The assembly of claim 1 wherein said wireless computer device connector comprises an IEEE 802.15-compatible transceiver.

12. The assembly of claim 1 wherein said mobile support platform comprises a wheeled platform positionable by wheeled movement at the provisioning location.

13. An assembly for facilitating computer-device provisioning of provisioning data at a provisioning location, said assembly comprising:
a wide area network transceiver having a communication range that includes the provisioning location, said wide area network transceiver configured to broadcast network-sourced computer data that forms the provisioning data;
wide area network infrastructure connected to said wide area network transceiver, the network-sourced computer data provided to said wide area network transceiver for broadcast therefrom by said wide area network infrastructure; and
a computer data source connected in communication connectivity with said wide area network transceiver, said computer data source configured to source the network-sourced computer data.

14. The assembly of claim 13 wherein the wide area network infrastructure comprises a cellular communication system network infrastructure.

15. A method for facilitating provisioning of a computer device with provisioning data at a provisioning location, said method comprising the operations of:
positioning a mobile-positionable wireless network connector at the provisioning location;
detecting, at the mobile-positionable wireless network connector, the network-sourced computer data broadcast in the provisioning location;
positioning a mobile-positionable communication device connector together with the wireless network connector and in wireless communication connectivity with the communication device; and
provisioning the computer device with the network-sourced data by way of the communication device connector, the network-sourced data forming the provisioning data.

16. The method of claim 15 wherein said operations of positioning the mobile-positionable wireless network connector and of positioning the mobile-positionable communication device connector comprise wheeling a support cart upon which the wireless network and communication device connectors, respectively, are supported.

17. The method of claim 15 further comprising the operation of broadcasting the network-sourced computer data by a wide area network device in the provisioning location.

18. The method of claim 15 wherein the mobile-positionable communication device connector positioned during said operation of positioning the mobile-positionable communication device connector comprises a Bluetooth™ transceiver.

19. The method of claim 15 wherein the mobile-positionable communication device connector positioned during said operation of positioning the mobile-positionable communication device connector comprises a wireless local area network, WLAN, point-to-point bridge.

20. The method of claim 15 wherein the mobile-positionable communication device connector positioned during said operation of positioning the mobile-positionable communication device connector comprises a wireless local area network, WLAN, point-to-multipoint bridge.
